(19) United States
(12) Patent Application Publication
(10) Pub. No.: US 2018/0056573 A1
(43) Pub. Date: Mar. 1, 2018

(54) THERMOFORMING MOLD FOR EVA AND METHOD FOR MAKING THE SAME

(71) Applicant: UNION-TECH (QING YUAN) MOLD MANUFACTURING CO., LTD., Qingyuan City (CN)

(72) Inventor: Rong-Wu Chang, Guang Dong Province (CN)

(21) Appl. No.: 15/483,328

(22) Filed: Apr. 10, 2017

(30) Foreign Application Priority Data
Aug. 29, 2016 (CN) 201610761818.4

(51) Int. Cl. B29C 51/30; B29C 33/38; B29C 51/00; B22D 21/00; B22D 19/00; B22D 25/02; B22C 9/02; B22C 9/22; B29D 35/12; A43B 13/04; A43B 13/12

(52) U.S. Cl. CPC B29C 51/30; B29C 33/3842; B29C 51/002; B22D 21/007; B22D 19/0072; B29K 2023/083; B22C 9/02; B22C 9/22; B29D 35/122; A43B 13/04; A43B 13/12; B22D 25/02

(57) ABSTRACT

The present invention relates to a thermoforming mold for EVA, comprising an upper aluminum mold and a lower aluminum mold, both of which are hinged and each provided with a handle, wherein, the upper aluminum mold is provided with a raised pattern, and the lower aluminum mold is provided with a sunken cavity, characterized in that an upper passage passing through the inside of the pattern is provided inside the upper aluminum mold, a lower passage passing through the bottom of the cavity is provided inside the lower aluminum mold, the upper passage has a first opening in the inner surface of the upper aluminum mold, the lower passage has a second opening corresponding to and communicated with the first opening in the inner surface of the lower aluminum mold, and both sides of the lower passage are provided with a vapor/water inlet and a vapor/water outlet respectively.

### FIELD OF THE INVENTION

The present invention relates to a method for making a mold, especially to a thermoforming mold for EVA and a method for making the same.

### BACKGROUND OF THE INVENTION

A traditional method for making a shaping aluminum mold for molding EVA (which needs to bury pipes in casting process) is that: when the shaping aluminum mold for molding EVA is cast, stainless steel pipes are needed to be buried in a sand mold followed by pouring molten aluminum into the sand mold, and then the stainless steel pipes may be embedded in the aluminum mold after the aluminum mold is cooled to retain the shape. The shaping aluminum mold for molding EVA made by this method has a disadvantage that the stainless steel with a heat conductivity of about 20 kcal/mh° C. conducts heat slow and needs longer periods for adding of sulfur and cooling, causing an extended manufacturing period and excessive energy consumption.

### SUMMARY OF THE INVENTION

The object of the present invention is to provide a thermoforming mold for EVA and a method for making the same that avoid the drawbacks of the prior art.

A thermoforming mold for EVA of the present invention comprises an upper aluminum mold and a lower aluminum mold, both of which are hinged and each provided with a handle, wherein, the upper aluminum mold is provided with a raised pattern, and the lower aluminum mold is provided with a sunken cavity, characterized in that an upper passage passing through the inside of the pattern is provided inside the upper aluminum mold, a lower passage passing through the bottom of the cavity is provided inside the lower aluminum mold, the upper passage has a first opening in the inner surface of the upper aluminum mold, the lower passage has a second opening corresponding to and communicated with the first opening in the inner surface of the lower aluminum mold, and both sides of the lower passage are provided with a vapor/water inlet and a vapor/water outlet respectively.

A method for making a thermoforming mold for EVA of the present invention comprises steps of:

(1) making a lower sand pattern shaping die: wood materials are used to make an upper die and a lower die of the lower sand pattern shaping die, the lower sand pattern shaping die is provided with a lower cavity with first openings at its both ends and a vapor/water entering and exiting cavity as well as a plurality of lower extruding openings, and the lower sand pattern may be extruded with the lower sand pattern shaping die;

(2) making an upper sand pattern shaping die: wood materials are used to make an upper die and a lower die of the upper sand pattern shaping die, the upper sand pattern shaping die is provided with an upper cavity, both ends of which are each provided with a second opening corresponding to the first opening, and the upper sand pattern may be extruded with the upper sand pattern shaping die;

(3) fixing the lower and upper sand patterns: the upper and lower sand patterns are fixed in a sand mold via aluminum blocks;

(4) pouring molten aluminum into the sand mold: molten aluminum is poured into the sand mold with the upper and lower sand patterns, the upper and lower sand patterns are removed after the shaped upper and lower aluminum molds are cooled to form an upper passage communicated with a lower passage inside the upper and lower aluminum molds respectively and a vapor/water inlet as well as a vapor/water outlet, and the upper aluminum mold and the lower aluminum mold may be finally obtained; and

(5) manufacture of the mold is finished.

The shaping aluminum mold of the present invention may mainly manufacture an end product of an EVA midsole integrally molded with a RB outsole. The pipes may be directly in contact with the aluminum mold, so heat can be conducted quickly. The shape of the sand mold can be changed as the size of the EVA end product changes, so the temperature of vapor and cold water can directly affect the shaping of the EVA end product more.

Advantages of the present invention compared with the prior art are as follows.

(1) The shaping aluminum mold for molding EVA manufactured by sand casting is a good conductor with a thermal conductivity of about 238 kcal/mh° C., which conducts 10 times faster than the stainless steel with a thermal conductivity of about 20 kcal/mh° C.; and

(2) In the process of that the shaping aluminum mold for molding EVA manufactured by sand casting manufactures an end product, periods for adding of sulfur and cooling are 380 seconds and 360 seconds respectively; while, in the process of that the shaping aluminum mold with buried pipes manufactures an end product, periods for adding of sulfur and cooling are 480 seconds and 450 seconds respectively, which means that, compared with the aluminum mold with buried pipes, the periods for adding of sulfur and cooling for the aluminum mold manufactured by sand casting are reduced by 100 seconds and 90 seconds respectively with a total reduction in time of 190 seconds, so the manufacturing period and energy consumption may be reduced by adopting the shaping aluminum mold for molding EVA manufactured by sand casting.

### BRIEF DESCRIPTION OF THE DRAWINGS

FIG. 1 is a schematic view of a thermoforming mold for EVA;

FIG. 2 is a schematic view of an upper aluminum mold;

FIG. 3 is a schematic view of a lower aluminum mold;

FIG. 4 is a schematic view of a lower sand pattern shaping die;

FIG. 5 is a schematic view of an upper sand pattern shaping die; and

FIG. 6 illustrates the fixing of the sand patterns around a sand mold.

### DETAILED DESCRIPTION OF THE PREFERRED EMBODIMENTS

Preferred embodiments of the present invention will be described below in detail with reference to the accompanying drawings.

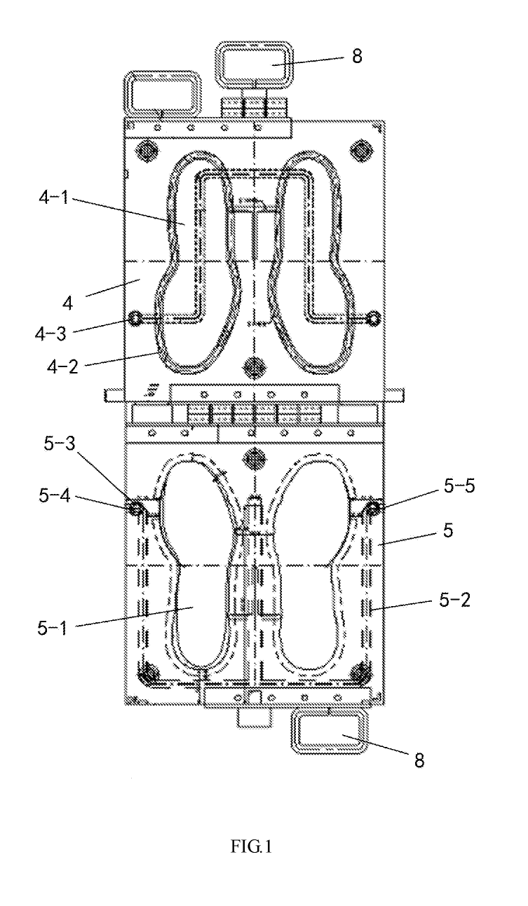

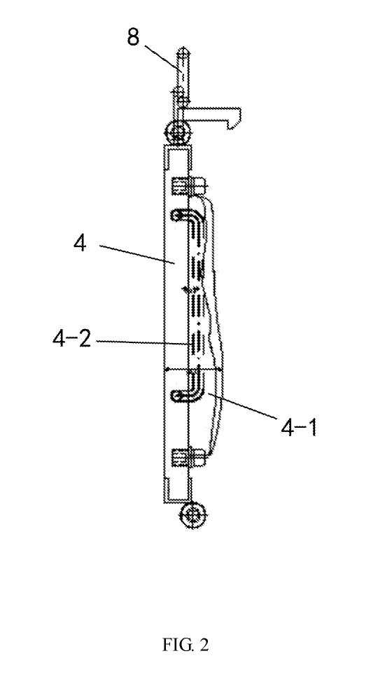

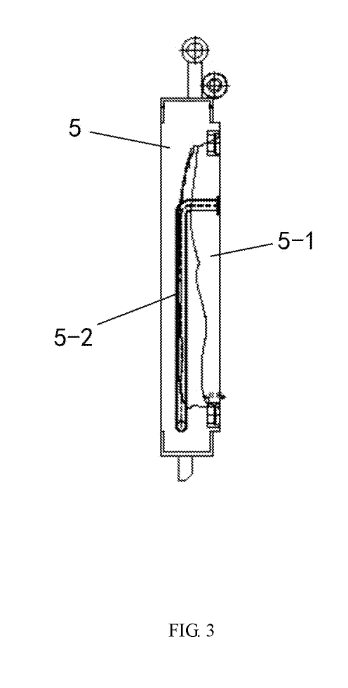

With reference to FIGS. 1, 2 and 3, a thermoforming mold for EVA in one embodiment comprises an upper aluminum mold 4 and a lower aluminum mold 5. The upper aluminum mold 4 and the lower aluminum mold 5 are hinged and each provided with a handle 8. The upper aluminum mold 4 is provided with a raised pattern 4-1, and the lower aluminum mold 5 is provided with a sunken cavity 5-1. An upper passage 4-2 passing through the inside of the pattern 4-1 is provided inside the upper aluminum mold 4, and a lower passage 5-2 passing through the bottom of the cavity 5-1 is provided inside the lower aluminum mold 5. The upper passage 4-2 has a first opening 4-3 in the inner surface of the upper aluminum mold 4, and the lower passage 5-2 has a second opening 5-3 corresponding to and communicated with the first opening 4-3 in the inner surface of the lower aluminum mold 5. Both sides of the lower passage 5-2 are provided with a vapor/water inlet 5-4 and a vapor/water outlet 5-5 respectively.

With reference to FIGS. 1 through 6, a process for manufacturing a thermoforming mold for EVA in one embodiment comprises steps of:

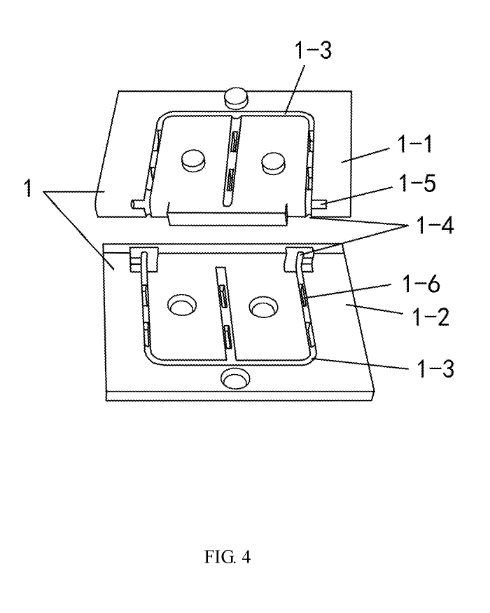

(1) making a lower sand pattern shaping die 1: as shown in FIG. 4, wood materials are used to make an upper die 1-1 and a lower die 1-2 of the lower sand pattern shaping die, the lower sand pattern shaping die is provided with a lower cavity 1-3 with first openings 1-4 at its both ends and a vapor/water entering and exiting cavity 1-5 as well as a plurality of lower extruding openings 1-6, and the lower sand pattern may be extruded with the lower sand pattern shaping die;

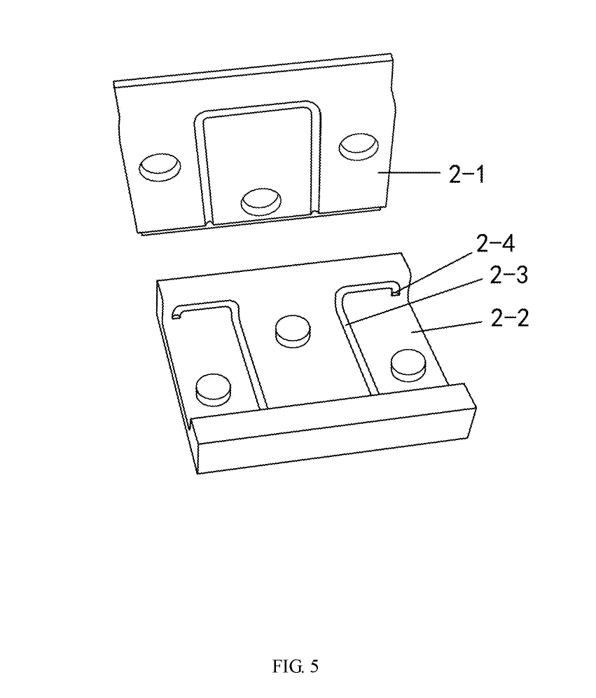

(2) making an upper sand pattern shaping die 2: as shown in FIG. 5, wood materials are used to make an upper die 2-1 and a lower die 2-2 of the upper sand pattern shaping die, the upper sand pattern shaping die 2 is provided with an upper cavity 2-3, both ends of which are each provided with a second opening 2-4 corresponding to the first opening 1-4, and the upper sand pattern may be extruded with the upper sand pattern shaping die;

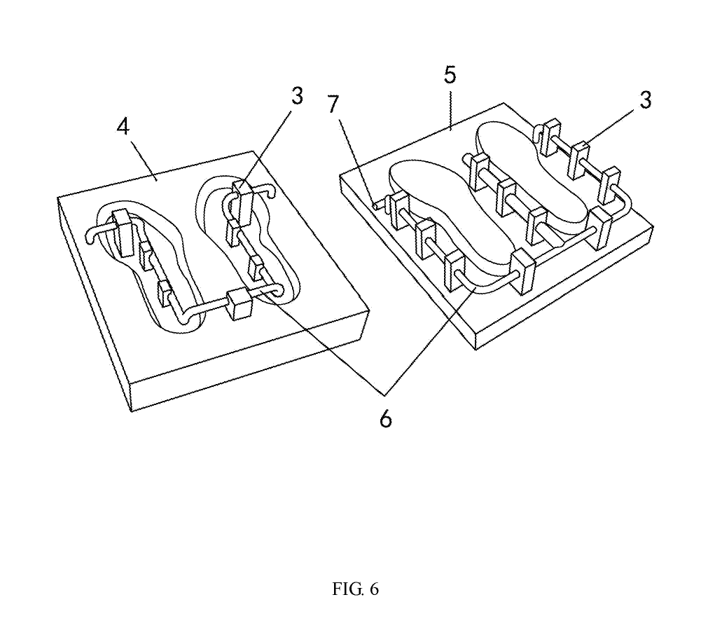

(3) fixing the lower and upper sand patterns: as shown in FIG. 6, the upper and lower sand patterns are fixed in a sand mold via aluminum blocks 3;

(4) pouring molten aluminum into the sand mold: as shown in FIGS. 1 through 3, molten aluminum is poured into the sand mold with the upper and lower sand patterns, the upper and lower sand patterns are removed after the shaped upper and lower aluminum molds are cooled to form an upper passage 4-2 communicated with a lower passage 5-2 inside the upper and lower aluminum molds respectively and a vapor/water inlet 5-4 as well as a vapor/water outlet 5-5, and the upper aluminum mold 4 and the lower aluminum mold 5 may be finally obtained; and

(5) manufacture of the mold is finished.

In the present invention, sand is extruded into pipe-like sand pattern with the sand pattern shaping dies. In casting step, the sand patterns are fixed around the end product area of the sand mold for EVA (as closely to the end product area as possible), and then the molten aluminum is poured in. The sand patterns are removed after the shaping aluminum mold for EVA is cooled to retain the shape so as to make pipes present in the aluminum mold.

The above described is merely preferred embodiments of the present invention, and not exemplified to intend to limit the present invention. Any modifications and changes without departing from the scope of the spirit of the present invention are deemed as within the scope of the present invention.

1. A thermoforming mold for EVA, comprising an upper aluminum mold and a lower aluminum mold, both of which are hinged and each provided with a handle, wherein, the upper aluminum mold is provided with a raised pattern, and the lower aluminum mold is provided with a sunken cavity, characterized in that
an upper passage passing through the inside of the pattern is provided inside the upper aluminum mold, a lower passage passing through the bottom of the cavity is provided inside the lower aluminum mold, the upper passage has a first opening in the inner surface of the upper aluminum mold, the lower passage has a second opening corresponding to and communicated with the first opening in the inner surface of the lower aluminum mold, and both sides of the lower passage are provided with a vapor/water inlet and a vapor/water outlet respectively.

2. A method for making a thermoforming mold for EVA, comprising steps of
(1) making a lower sand pattern shaping die, wherein, wood materials are used to make an upper die and a lower die of the lower sand pattern shaping die, the lower sand pattern shaping die is provided with a lower cavity with first openings at its both ends and a vapor/water entering and exiting cavity as well as a plurality of lower extruding openings, and the lower sand pattern may be extruded with the lower sand pattern shaping die;
(2) making an upper sand pattern shaping die, wherein, wood materials are used to make an upper die and a lower die of the upper sand pattern shaping die, the upper sand pattern shaping die is provided with an upper cavity, both ends of which are each provided with a second opening corresponding to the first opening, and the upper sand pattern may be extruded with the upper sand pattern shaping die;
(3) fixing the lower and upper sand patterns, wherein, the upper and lower sand patterns are fixed in a sand mold via aluminum blocks;
(4) pouring molten aluminum into the sand mold, wherein, molten aluminum is poured into the sand mold with the upper and lower sand patterns, the upper and lower sand patterns are removed after the shaped upper and lower aluminum molds are cooled to form an upper passage communicated with a lower passage inside the upper and lower aluminum molds respectively and a vapor/water inlet as well as a vapor/water outlet, and the upper aluminum mold and the lower aluminum mold may be finally obtained; and
(5) manufacture of the mold is finished.
